(19) United States
(12) Patent Application Publication
(10) Pub. No.: US 2025/0265465 A1
(43) Pub. Date: Aug. 21, 2025

(54) PROGRESSIVE BANDWIDTH-LATENCY OPTIMIZATION OF LARGE MODELS

(71) Applicant: Cisco Technology, Inc., San Jose, CA (US)

(72) Inventors: Gaowen LIU, Austin, TX (US); Myungjin LEE, Bellevue, WA (US); Ramana Rao V. R. KOMPELLA, Foster City, CA (US)

(73) Assignee: Cisco Technology, Inc., San Jose, CA (US)

(21) Appl. No.: 18/442,930

(22) Filed: Feb. 15, 2024

(51) Int. Cl. G06N 3/082

(52) U.S. Cl. CPC G06N 3/082

(57) ABSTRACT

In one embodiment, a method herein comprises: distributing a plurality of pipelined layers of a machine learning model among a plurality of individual devices connected via a computer network; determining a subset of the plurality of pipelined layers that are fringe layers that interconnect between the plurality of individual devices via the computer network; generating compressed fringe layers by reducing parameters of the fringe layers; and executing the machine learning model with an input passed through the plurality of pipelined layers to produce an output, wherein communication between the plurality of individual devices is based on the compressed fringe layers.

### TECHNICAL FIELD

The present disclosure relates generally to computer networks, and, more particularly, to progressive bandwidth-latency optimization of large models.

### BACKGROUND

As machine learning/artificial intelligence techniques continue to evolve and mature, the number of use cases for these techniques also continue to increase. For instance, video analytics techniques are becoming increasingly ubiquitous as a complement to new and existing surveillance systems. In such deployments, a neural network-based person detection and reidentification now allows for a specific person to be tracked across different video feeds throughout a location. More advanced video analytics techniques also attempt to detect certain types. Other use cases also range from sensor analytics, to (semi-) autonomous vehicles, to network security, to name a few. In many cases, the machine learning/artificial intelligence models underlying the above use cases are becoming increasingly resource-intensive. This makes deploying such a model to a singular device for execution unfeasible due to the resource constraints of the target device. While it may be possible to split the model for distributed execution across multiple devices, doing so also makes the performance of the overall model a function of the performance of the network connecting those devices, as well.

### BRIEF DESCRIPTION OF THE DRA WINGS

The embodiments herein may be better understood by referring to the following description in conjunction with the accompanying drawings in which like reference numerals indicate identically or functionally similar elements, of which:

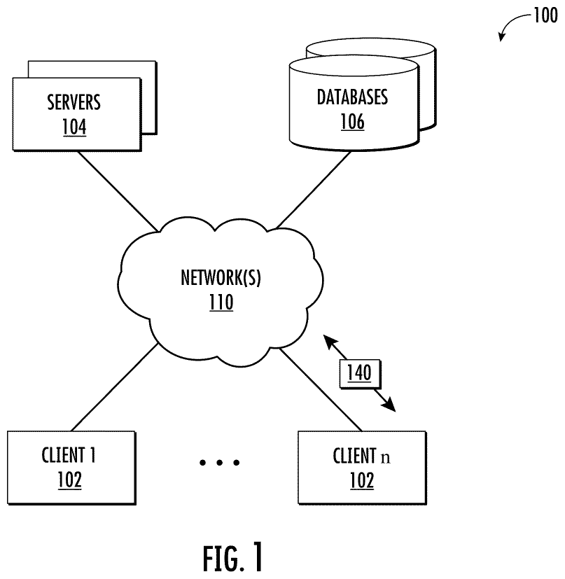

FIG. 1 illustrates an example computing system;

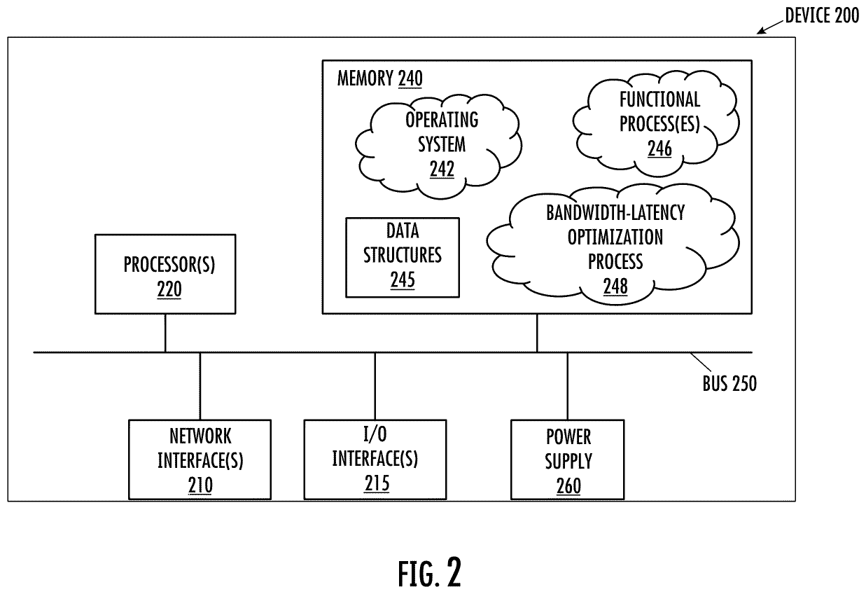

FIG. 2 illustrates an example network device/node;

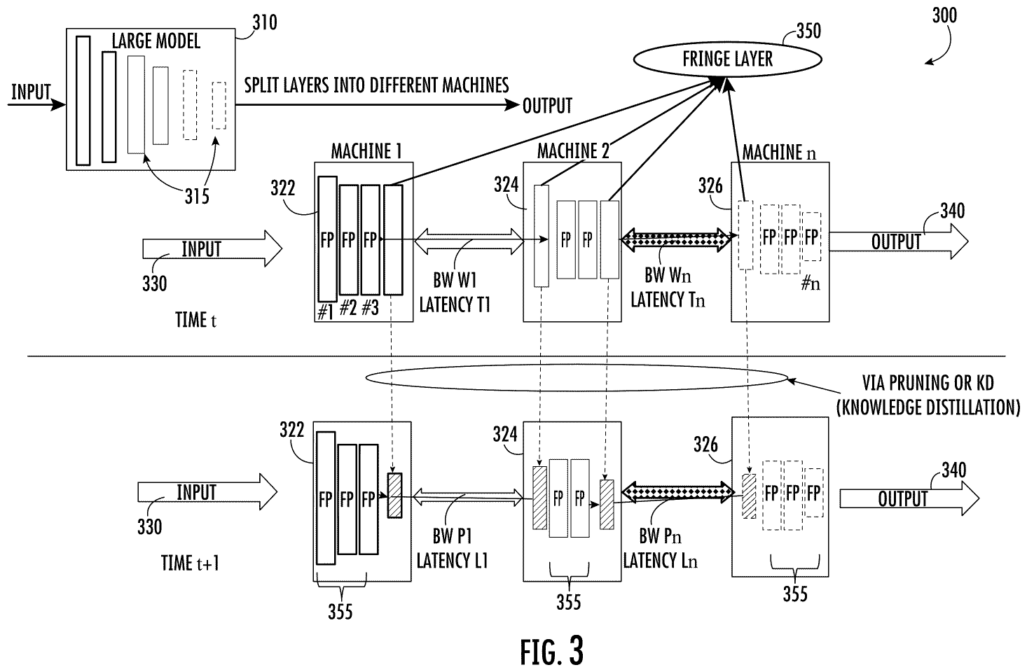

FIG. 3 illustrates an example deployment of a pre-trained model across a distributed set of devices, where the original pipeline goes through all layers of the model;

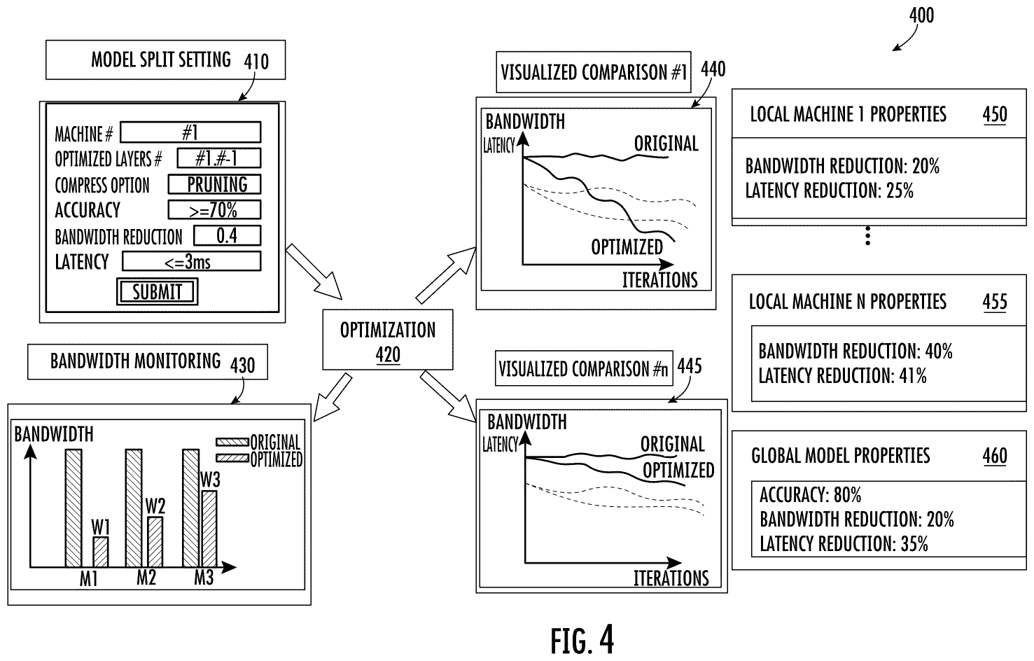

FIG. 4 illustrates an example user interface to control a bandwidth and latency optimization system herein; and

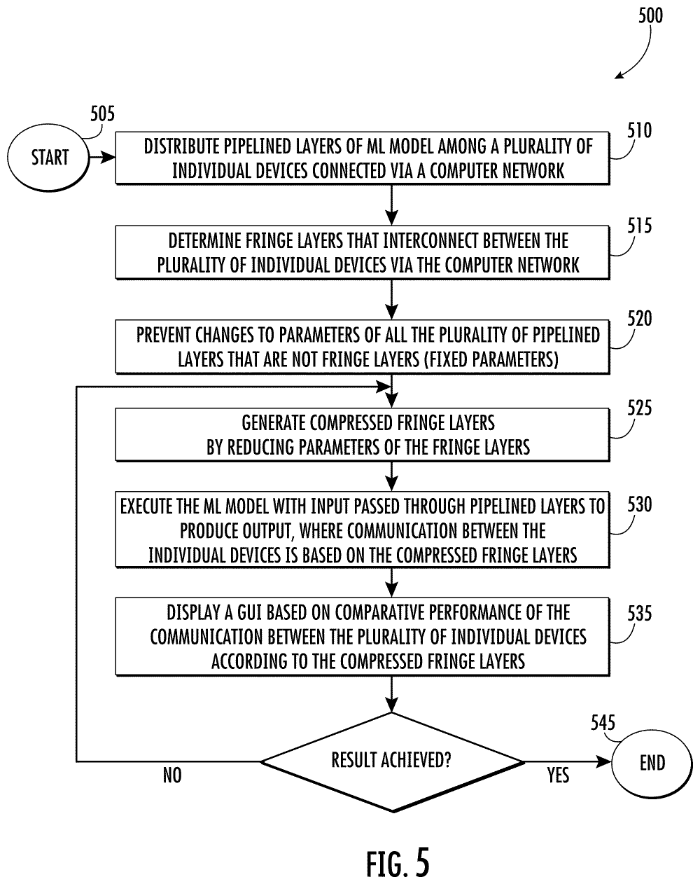

FIG. 5 illustrates an example procedure for progressive bandwidth-latency optimization of large models.

### DESCRIPTION OF EXAMPLE EMBODIMENTS

### Overview

According to one or more embodiments of the disclosure, a method herein comprises: distributing a plurality of pipelined layers of a machine learning model among a plurality of individual devices connected via a computer network; determining a subset of the plurality of pipelined layers that are fringe layers that interconnect between the plurality of individual devices via the computer network; generating compressed fringe layers by reducing parameters of the fringe layers; and executing the machine learning model with an input passed through the plurality of pipelined layers to produce an output, wherein communication between the plurality of individual devices is based on the compressed fringe layers.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a bandwidth-latency optimization process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, bandwidth-latency optimization process (process 248) may include computer executable instructions that, when executed by processor(s) 220, cause device 200 to perform the techniques described herein. To do so, in some implementations, process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, or the like.

In further implementations, process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### —Progressive Bandwidth-Latency Optimization of Large Models—

As noted above, machine learning/artificial intelligence (ML/AI) techniques continue to evolve and mature, the number of use cases for these techniques also continue to increase. However, the ML/AI models underlying these use cases are becoming increasingly resource-intensive, making deploying such a model to a singular device for execution unfeasible due to the resource constraints of the target device. As also noted above, while it may be possible to split the model for distributed execution across multiple devices, doing so also makes the performance of the overall model a function of the performance of the network connecting those devices, as well.

The techniques herein, therefore, address the above issues with progressive bandwidth-latency optimization of large models. In particular, the techniques herein provide for the dynamic adjustment of a machine learning model executed across a distributed set of devices, to take into account the performance of the network itself.

Specifically, according to one or more embodiments of the disclosure as described in detail below, a method herein comprises: distributing a plurality of pipelined layers of a machine learning model among a plurality of individual devices connected via a computer network; determining a subset of the plurality of pipelined layers that are fringe layers that interconnect between the plurality of individual devices via the computer network; generating compressed fringe layers by reducing parameters of the fringe layers; and executing the machine learning model with an input passed through the plurality of pipelined layers to produce an output, wherein communication between the plurality of individual devices is based on the compressed fringe layers.

Generally, machine learning models, particularly large models (e.g., neural networks), are composed of layers and parameters. An input layer receives the input data, and passes the input data in a pipeline through a number of intermediate layers (or “hidden layers”) between the input layer and an ultimate output layer that provides the output of the model. The purpose of the intermediate layers is to process the inputs received from the input layer and process the complex patterns. The number and size of intermediate/hidden layers vary depending on the complexity of the task. Also, intermediate layers may be different types as well, such as, e.g., dense (fully connected), convolutional, recurrent, pooling, and so on, as will be appreciated by those skilled in the art. Parameters, on the other hand, comprise things such as weights (e.g., the coefficients that apply to each input, adjusted during training to minimize the error of the model), biases (e.g., additional parameters added provide flexibility to the model), and hyperparameters. Unlike weights and biases, hyperparameters are not learned, but are instead set prior to the training process and include things such as learning rate, number of epochs, batch size, etc.

Operationally, the techniques herein involve a progressive compression pipeline that dynamically performs pruning or knowledge distillation (KD) based on the performance of the network connecting the devices executing different portions of the model.

FIG. 3 illustrates an example deployment 300 of a pre-trained model across a distributed set of devices, where the original pipeline goes through all layers of the model. For instance, as shown, a large model 310 has parameters 315 (parameters 1-n) of different layers (shown as solid, dashed, and dotted outlines to illustrate each layer). The techniques herein may split the layers into different machines 1-n, such as machine 322, machine 324, and machine 326 as shown. Now, at time “t”, an input 330 enters the large model 310 via machine 322 and its parameters first, passing to machine 324 with its parameters, to machine 326 with its parameters before producing an output 340. Note that the bandwidth (BW) between machine 322 and machine 324 is denoted as “W1”, and the latency is “T1”. Also, between machine 324 and machine 326 bandwidth is “Wn” and latency is “Tn”.

According to the techniques herein, the proposed pipeline will freeze the parameters of most of the layers (called “fixed parameters 355” or “FP”) and compress a few particular layers of interest. Namely, the layers of interest for compression are those that are connected across communication networks at the “fringe” of each machine (i.e., fringe layers 350). In one embodiment, compression for fringe layers 350 (the layers connecting the separate machines through communication networks, such as computing system 100) may take place at serving time (i.e., at inference time).

The benefit here is that the model does not have to update all parameters in each iteration. Also, according to the techniques herein specifically, the number of parameters of fringe layers may be reduced, allowing the information transmission between machines to be reduced. The reduction of information transmission thus leads to bandwidth and latency reduction (e.g., for machine 322 to machine 324, bandwidth “W1” to “P1” and latency “T1” to “L1”, and for machine 324 to machine 326, bandwidth “Wn” to “Pn” and latency “Tn” to “Ln”, and so on), accordingly.

Notably, the progressive compression of the fringe layers 350 may take place over multiple units of time. FIG. 3 only shows time “t” and “t+1” for demonstration purposes, but multiple iterations over time may provide even further progressive compression, accordingly. Also, only a certain number of machines and layers are shown, but any number of each may be used in accordance with the techniques herein.

In order to achieve progressive compression, the techniques herein may illustratively leverage various pruning techniques or knowledge distillation (KD). Regarding latency, bandwidth, and accuracy optimization, the target of the techniques herein is to reduce the parameters of the fringe layers (parameters of fringe layer 350) and keep the other layers frozen (fixed parameters 355). That is, the techniques herein can reduce the parameters of fringe layers by pruning progressively based on the feedback of the pre-trained model, or by constructing a new layer architecture and performing knowledge distillation:
When applying pruning, the techniques herein can set the threshold for accuracy and progressively prune the layer until reaching the bottom line of accuracy, thus reducing the amount of bandwidth and the latency.
When applying knowledge distillation (KD), the bandwidth and latency will be fixed according to user's specific use cases, then the techniques herein may apply KD to recover accuracy.

Parameter pruning in machine learning, in particular, is a technique used to reduce the complexity of a model by removing some of its parameters (weights and biases). This is typically done to improve computational efficiency and reduce the model's memory footprint. It can also help in reducing overfitting, making the model more generalizable to unseen data. Various pruning techniques may be used herein, such as identifying and removing redundant parameters (those that contribute least to the model's output), through either unstructured pruning (removing individual weights) and/or structured pruning (removing entire neurons or layers).

Knowledge distillation, on the other hand, is a technique used to transfer knowledge from a larger, more complex model (often referred to as the “teacher” model) to a smaller, simpler model (known as the “student” model). The goal is to enable the student model to achieve performance close to that of the teacher model while being more efficient in terms of computational resources.

Notably, the amount of bandwidth reduction and latency reduction may be calculated according to the following formulas:

$$Bandwidth Reduction = {\sum }_{1}^{n} Wi - {\sum }_{1}^{n} Pi \qquad Eq . 1$$

$$Latency Reduction = {\sum }_{1}^{n} Ti - {\sum }_{1}^{n} Li \qquad Eq . 2$$

Moreover, under the techniques herein, compression can be made under system and/or user control, and may be based on constraints of the underlying deployment environment, such as available network bandwidth and/or desired latency.

FIG. 4 illustrates an example user interface 400 to control the bandwidth and latency optimization system herein. The user interface 400 (e.g., a graphical user interface, a command line interface, etc.) may have a model split setting control 410, which as shown may be where a particular machine may be chosen and a number of optimized layers may be selected. A compression option may be selected (e.g., pruning or knowledge distillation, among others), and a desired accuracy may be set (e.g., greater than a defined threshold percentage). Optionally, a desired bandwidth reduction (e.g., a factor, percentage, or amount) and a desired latency (e.g., a set maximum amount, a desired reduction, etc.) may each be set by the user, accordingly.

According to other implementations of the techniques herein, the settings of model splits may be configured automatically by one or more algorithms, such as rule-based settings, machine learning/artificial intelligence algorithms, or otherwise.

After submitting the split settings, the optimization process 420 may begin iterating on the pipeline, where bandwidth monitoring 430 may compute and illustrate a difference between original bandwidth and optimized bandwidths for each machine of the pipeline, and visualization comparisons #1-n (e.g., visualization comparison 440, visualization comparison 445, etc.) may then illustrate original and optimized bandwidth and latency over the course of such iterations. Properties for each of the local machines 1-n may also be illustrated, such as properties 450 for machine #1 (e.g., bandwidth reduction 20%, latency reduction 25%, etc.), properties 455 for machine #n (e.g., bandwidth reduction 40%, latency reduction 41%, etc.), and so on. Also, global model properties 460 may show collective properties, such as accuracy (e.g., 80%), total bandwidth reduction (e.g., 20%), and total latency reduction (e.g., 35%).

FIG. 5 illustrates an example simplified procedure for progressive bandwidth-latency optimization of large models in accordance with one or more embodiments described herein. For example, a non-generic, specifically configured device (e.g., device 200, an apparatus or “controlling device”) may perform procedure 500 by executing stored instructions (e.g., process 248). The procedure 500 may start at step 505, and continues to step 510, where, as described in greater detail above, the techniques herein distribute a plurality of pipelined layers of a machine learning model among a plurality of individual devices connected via a computer network.

In step 515, the techniques herein may then determine a subset of the plurality of pipelined layers that are fringe layers that interconnect between the plurality of individual devices via the computer network. According to the techniques herein, in step 520 charges to parameters of all the plurality of pipelined layers that are not fringe layers are prevented (i.e., to establish the fixed parameters described above). However, in step 525, as detailed above, the techniques herein generate compressed fringe layers by reducing parameters of the fringe layers, accordingly.

In particular, as described above, compressing the fringe layers (i.e., generating the compressed fringe layers) may be based on performance of the computer network, and may be based on receiving user-based control through a user interface or else based on automated system-based control (e.g., based on one or more constraints of the computer network). For example, as noted above, reducing parameters of the fringe layers may be according to one or more control options selected from a group consisting of: a number of pipelined layers; a type of layer compression mechanism; a minimum accuracy threshold for the machine learning model; a minimum bandwidth reduction; and a maximum latency. Also, generating the compressed fringe layers may occur at serving time, as noted.

In one implementation herein, as described above, reducing the parameters of the fringe layers may be performed by progressively pruning the parameters of the fringe layers based on an accuracy of the machine learning model reaching a minimum accuracy threshold for the machine learning model. Alternatively, reducing the parameters of the fringe layers may be based on using knowledge distillation to construct an updated layer architecture for the machine learning model based on achieving a minimum accuracy threshold for the machine learning model according to a set value of one or both of bandwidth or latency of the communication between the plurality of individual devices.

In step 530, the techniques herein may then execute the machine learning model with an input passed through the plurality of pipelined layers to produce an output, where communication between the plurality of individual devices is based on the compressed fringe layers. According to the techniques herein, reducing parameters of the fringe layers consequently reduces information transmission for the communication between the plurality of individual devices, thereby reducing one or both of bandwidth or latency of the communication between the plurality of individual devices.

In step 535, the techniques herein may optionally display a graphical user interface (GUI) based on comparative performance of the communication between the plurality of individual devices according to the compressed fringe layers, similar to that shown in FIG. 4 above. For instance, the comparative performance may be based on progressive iterations of compression of the fringe layers, and may be selected from a group consisting of: connection-based bandwidth reduction; connection-based latency reduction; global bandwidth reduction; global latency reduction; and accuracy of the machine learning model, among others.

As mentioned, in step 540, if a desired result is not achieved, e.g., a desired reduction in one or both of bandwidth or latency of the communication between the plurality of individual devices is not yet achieved (while notably achieving a desired minimum accuracy threshold), then the procedure 500 returns to step 525 to progressively compress the compressed fringe layers through iterations of executing the machine learning model.

Once the desired results are achieved in step 540, the procedure 500 may end at step 545, accordingly.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: distributing a plurality of pipelined layers of a machine learning model among a plurality of individual devices connected via a computer network; determining a subset of the plurality of pipelined layers that are fringe layers that interconnect between the plurality of individual devices via the computer network; generating compressed fringe layers by reducing parameters of the fringe layers; and executing the machine learning model with an input passed through the plurality of pipelined layers to produce an output, wherein communication between the plurality of individual devices is based on the compressed fringe layers.

In still other implementations, a tangible, non-transitory, computer-readable medium storing program instructions that cause a device to execute a process comprising: distributing a plurality of pipelined layers of a machine learning model among a plurality of individual devices connected via a computer network; determining a subset of the plurality of pipelined layers that are fringe layers that interconnect between the plurality of individual devices via the computer network; generating compressed fringe layers by reducing parameters of the fringe layers; and executing the machine learning model with an input passed through the plurality of pipelined layers to produce an output, wherein communication between the plurality of individual devices is based on the compressed fringe layers.

The techniques described herein, therefore, provide for progressive bandwidth-latency optimization of large models. In particular, while other techniques in use today attempt to reduce memory footprints, such techniques do not focus on the connection layers to reduce the bandwidth communication, as is done in accordance with the techniques herein. Also, as opposed to current techniques that place a full model on each devices, the techniques herein configures each device to only support a part of a full model, accordingly. Lastly, while activation pruning is a technique used for split computing in edge AI, the techniques herein propose a different set of algorithms for a different targeted solution, involving both weight pruning and activation pruning to achieve progressive bandwidth-latency optimization, as described above.

Illustratively, the techniques described herein may be performed by hardware, software, and/or firmware, (e.g., an “apparatus”) such as in accordance with the bandwidth-latency optimization process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
distributing, by a controller device, a plurality of pipelined layers of a machine learning model among a plurality of individual devices connected via a computer network;
determining, by the controller device, a subset of the plurality of pipelined layers that are fringe layers that interconnect between the plurality of individual devices via the computer network;
generating, by the controller device, compressed fringe layers by reducing parameters of the fringe layers; and
executing, by the controller device, the machine learning model with an input passed through the plurality of pipelined layers to produce an output, wherein communication between the plurality of individual devices is based on the compressed fringe layers.

2. The method of claim 1, further comprising:
progressively compressing the compressed fringe layers through iterations of executing the machine learning model until a desired reduction in one or both of bandwidth or latency of the communication between the plurality of individual devices is achieved.

3. The method of claim 1, wherein generating the compressed fringe layers is based on performance of the computer network.

4. The method of claim 1, further comprising:
preventing changes to parameters of all the plurality of pipelined layers that are not fringe layers.

5. The method of claim 1, wherein reducing parameters of the fringe layers consequently reduces information transmission for the communication between the plurality of individual devices, thereby reducing one or both of bandwidth or latency of the communication between the plurality of individual devices.

6. The method of claim 1, further comprising:
reducing the parameters of the fringe layers by progressively pruning the parameters of the fringe layers based on an accuracy of the machine learning model reaching a minimum accuracy threshold for the machine learning model.

7. The method of claim 1, further comprising:
reducing the parameters of the fringe layers using knowledge distillation to construct an updated layer architecture for the machine learning model based on achieving a minimum accuracy threshold for the machine learning model according to a set value of one or both of bandwidth or latency of the communication between the plurality of individual devices.

8. The method of claim 1, wherein generating the compressed fringe layers is based on receiving user-based control through a user interface.

9. The method of claim 1, wherein generating the compressed fringe layers is based on automated system-based control.

10. The method of claim 9, wherein the automated system-based control is based on one or more constraints of the computer network.

11. The method of claim 1, wherein generating the compressed fringe layers by reducing parameters of the fringe layers according to one or more control options selected from a group consisting of: a number of pipelined layers; a type of layer compression mechanism; a minimum accuracy threshold for the machine learning model; a minimum bandwidth reduction; and a maximum latency.

12. The method of claim 1, wherein generating the compressed fringe layers occurs at serving time.

13. The method of claim 1, further comprising:
displaying a graphical user interface based on comparative performance of the communication between the plurality of individual devices according to the compressed fringe layers.

14. The method of claim 13, wherein the comparative performance is based on progressive iterations of compression of the fringe layers and is selected from a group consisting of: connection-based bandwidth reduction; connection-based latency reduction; global bandwidth reduction; global latency reduction; and accuracy of the machine learning model.

15. An apparatus, comprising:
one or more network interfaces to communicate with a network;
a processor coupled to the one or more network interfaces and configured to execute one or more processes; and
a memory configured to store a process that is executable by the processor, the process comprising:
distributing a plurality of pipelined layers of a machine learning model among a plurality of individual devices connected via a computer network;
determining a subset of the plurality of pipelined layers that are fringe layers that interconnect between the plurality of individual devices via the computer network;
generating compressed fringe layers by reducing parameters of the fringe layers; and
executing the machine learning model with an input passed through the plurality of pipelined layers to produce an output, wherein communication between the plurality of individual devices is based on the compressed fringe layers.

16. The apparatus of claim 15, the process further comprising:
progressively compressing the compressed fringe layers through iterations of executing the machine learning model until a desired reduction in one or both of bandwidth or latency of the communication between the plurality of individual devices is achieved.

17. The apparatus of claim 15, the process further comprising:
preventing changes to parameters of all the plurality of pipelined layers that are not fringe layers.

18. The apparatus of claim 15, the process further comprising:
reducing the parameters of the fringe layers by progressively pruning the parameters of the fringe layers based on an accuracy of the machine learning model reaching a minimum accuracy threshold for the machine learning model.

19. The apparatus of claim 15, the process further comprising:
reducing the parameters of the fringe layers using knowledge distillation to construct an updated layer architecture for the machine learning model based on achieving a minimum accuracy threshold for the machine learning model according to a set value of one or both of bandwidth or latency of the communication between the plurality of individual devices.

20. A tangible, non-transitory, computer-readable medium storing program instructions that cause a device to execute a process comprising:
distributing a plurality of pipelined layers of a machine learning model among a plurality of individual devices connected via a computer network;
determining a subset of the plurality of pipelined layers that are fringe layers that interconnect between the plurality of individual devices via the computer network;
generating compressed fringe layers by reducing parameters of the fringe layers; and
executing the machine learning model with an input passed through the plurality of pipelined layers to produce an output, wherein communication between the plurality of individual devices is based on the compressed fringe layers.
